(19) United States
(12) Patent Application Publication
(10) Pub. No.: US 2026/0227013 A1
(43) Pub. Date: Aug. 6, 2026

(54) ADAPTOR WITH RELIEF GATES

(71) Applicant: Cooper-Standard Automotive Inc., Northville, MI (US)

(72) Inventors: Christian A. Veraza, Auburn Hills, MI (US); Corey Roy Knight, Commerce Twp., MI (US)

(73) Assignee: Cooper-Standard Automotive Inc., Northville, MI (US)

(21) Appl. No.: 19/044,575

(22) Filed: Feb. 3, 2025

(51) Int. Cl. F16L 21/00

(52) U.S. Cl. CPC F16L 21/002

(57) ABSTRACT

The disclosure relates to a tubular body adaptor for connecting a first tubular body with a second tubular body. The adaptor has a first cylindrical wall defining a first socket for receiving an end of the first tubular body. The first cylindrical wall has a relief segment forming a drain through the first cylindrical wall.

### FIELD

The field is related to a process and apparatus for forming an adaptor for connecting one tubular body to another tubular body in fluid tight communication, and more particularly an adaptor for connecting one tubular body to another for forming fluid pathways in a coolant system of a vehicle such as an automobile or truck.

### BACKGROUND

Numerous fluid conveyance systems are required to operate wheeled vehicles such as automobiles, motorcycles, and trucks. An example of a fluid conveyance system is a coolant system for a vehicle. Coolant systems for internal combustion engines and electric vehicles use a coolant pump to drive a flow of a coolant liquid through hoses, pipes, or tubing into contact with a heat generating component to remove heat from the component. The now heated coolant liquid is conveyed away from the component through the hoses, pipes, or tubing into a radiator where heat is exchanged with the environment. The cooled liquid is then returned through the hoses, pipes, or tubing to the heat generating component in a continuous cycle. Establishing a fluid pathway in a coolant system for an internal combustion engine can be quite complicated. Hoses must be cut to length and secured in place inside an engine compartment of a vehicle. Typically, grommets, connectors, adaptors, elbows and tees are used to route the hose from location to location. The hose must maintain a fluid tight seal at each connection point to avoid leaks. A problem occurs when a tubular body is connected to an adaptor and creates an annular gap between an outer surface of the tubular body and an inner surface of the adaptor. In use, the annular gap collects liquid and particulate debris that is unsightly and potentially hazardous to the integrity of the fluid system and lead to leaks. For example, salt deposits can fall into the pooled liquid and make a liquid that is corrosive to the tube and connection. Thus, it is desirable to provide an adaptor that has a drain line for preventing the accumulation of liquid and particulate material.

### SUMMARY

This disclosure relates to a tubular body adaptor for connecting a first tubular body with a second tubular body. The adaptor has a first cylindrical wall defining a first socket for receiving an end of the first tubular body. The first cylindrical wall has a relief segment forming a drain through the first cylindrical wall.

This disclosure also relates to an adaptor and tubular body assembly. The assembly has a first tubular body having a first end and a tubular adaptor. The tubular adaptor has a first cylindrical wall defining a first socket surrounding the first end of the first tubular body. The first cylindrical wall has a relief segment forming a drain through the first cylindrical wall. An annular channel is delimited by an exterior surface of the first tubular body and an interior surface of the first socket. A drain is provided through the first cylindrical wall connecting the annular channel to an exterior of the adaptor.

This disclosure also relates to a tubular body adaptor for connecting a first tubular body with a second tubular body having a first cylindrical wall defining a first socket for receiving an end of the first tubular body. The first cylindrical wall has a relief segment forming a drain through the first cylindrical wall. A second cylindrical wall supports the first cylindrical wall and is coaxially disposed with respect thereto and has an outer diameter greater than an outer diameter of the first cylindrical wall.

### BRIEF DESCRIPTION OF THE DRAWINGS

FIG. 1 is a perspective front and top view of an adaptor of the present invention.

FIG. 2 is a perspective side elevation view in vertical cross section of an adaptor of the present invention.

FIG. 3 is a sectional view of the adaptor of FIG. 2 taken at segment 3-3.

FIG. 4 is a top schematic view of an adaptor and tubular body assembly of the present invention.

While the following is described in conjunction with specific embodiments, it will be understood that this description is intended to illustrate and not limit the scope of the preceding description and the appended claims.

### DETAILED DESCRIPTION

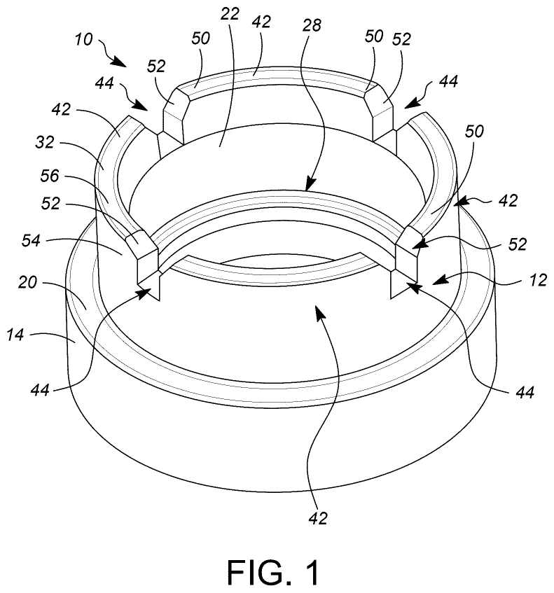

FIG. 1 shows a tubular body adaptor 10, or simply an adaptor 10, having a first cylindrical wall 12 stacked on top of a second cylindrical wall 14, or in other words, is coaxially disposed with respect thereto. The first cylindrical wall 12 has alternating wall segments 42 and relief gates 44 to define a castellated profile. Four wall segments 42 and four relief gates 44 are shown. The number of wall segments 42 and relief gates 44 could be from one to eight segments, more preferably from two segments to six segments, and most preferably from three segments to five segments. A bridging wall 20 having a planar outer surface connects the first cylindrical wall 12 to the second cylindrical wall 14. The bridging wall 20 extends inwardly of the first cylindrical wall 12 and the second cylindrical wall 14 to define an annular ledge 28.

Each wall segment 42 has opposed ends 50 terminating in a tapered surface 52 that forms a circumferential angle 54 with a horizontal. The angle 54 is from about 20° to about 80°, more preferably from about 25° to about 70°, even more preferably from about 30° to about 60°, and most preferably from about 35° to about 55°. The tapered surfaces 52 define chamfers for the relief gates 44.

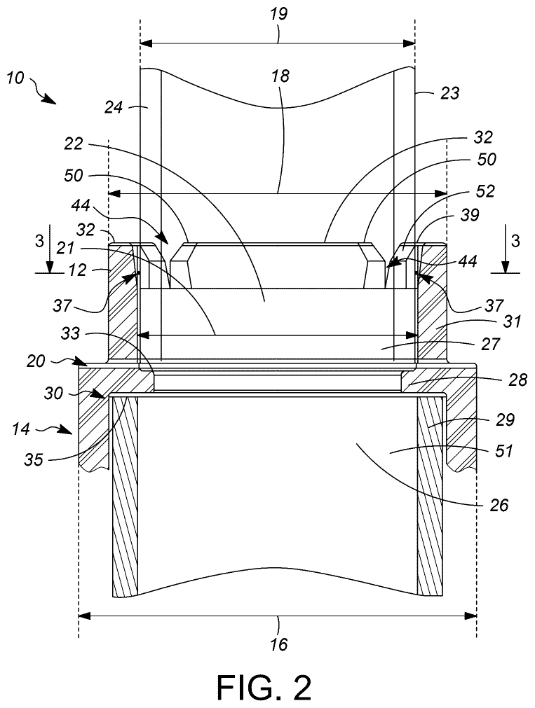

FIG. 2 shows the adaptor 10 receiving an end of two tubular bodies 24 and 29. The first cylindrical wall 12 has an inner diameter 19 and an outer diameter 18. The second cylindrical wall 14 has an outer diameter 16 and perhaps an inner diameter greater than an outer diameter 18 of the first cylindrical wall 12. The first cylindrical wall 12 defines a first socket 22 for receiving an end 27 of a first tubular body 24 and the second cylindrical wall 14 defines a second socket 26 for receiving an end 51 of a second tubular body 29. The first tubular body 24 has an outer diameter 21 that is smaller than the inner diameter 19 of the first cylindrical wall 12 leaving a slight gap 39 therebetween when mated together.

The annular ledge 28 extends from an interior wall 31 of the first cylindrical wall 12 to define an end stop for the first socket 22. The other side of the annular ledge 28 extends from an interior wall 30 of the second cylindrical wall 14 to define an end stop for the second socket 26. A first surface 33 of the annular flange 28 is for abutting against an end 27 of the first tubular body 24 and an opposite second surface 35 of the annular flange 28 is for abutting against an end 51 of the second tubular body 29.

A laser weld 37 may be employed to bond an outer surface 23 of the first tubular body 24 to the interior wall 31 of the first cylindrical wall 12 defining the first socket 22. During use such as in a road vehicle, liquid may collect in a reservoir provided in the annular gap 39 between the outer surface 23 of the first tubular body 24, the interior wall 31 and the weld 37.

The liquid may also collect salts and become corrosive to the weld 37 and or to the adaptor 12 and the first tubular body 24. The relief gate 44 is a gap that acts as a drain for pooling liquid to drain outwardly of the make-shift reservoir to prevent pooling and corrosion. The relief gate 44 may also serve as a locator for tooling. The relief gate 44 may be generally U-shaped.

It can be seen in FIGS. 1 and 2 that the first cylindrical wall 12 has a lead-in outer edge 32 that tapers inwardly at an angle from about 2° to about 10° with a longitudinal axis of the first cylindrical wall 12 so an outer edge is taller than an inner edge. The lead-in outer edge 32 facilitates entry of the tubular body 24.

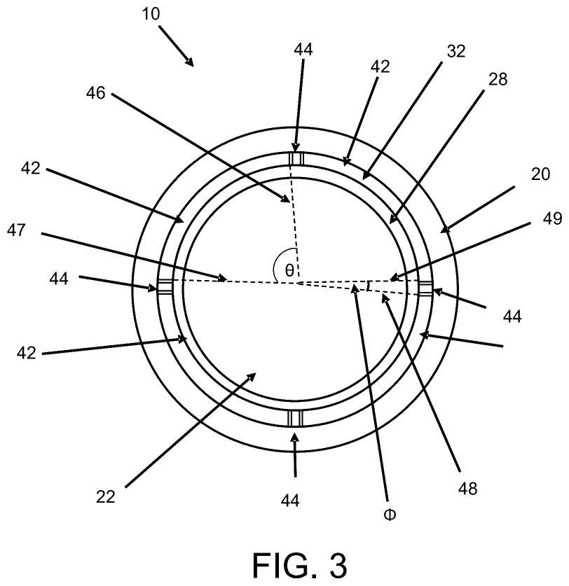

FIG. 3 shows a sectional view of the adaptor 10 of FIG. 2 taken at segment 3-3 but without the tubular body 24. The bridging wall 20 is visible as is the annular ledge 28 inside the first socket 22. The four wall segments 42 are preferably equal in arcuate length as indicated between dashed lines 46, 47, and each spans an angle 0 from about 70° to about 88°, more preferably from about 73° to about 87°, and most preferably from about 75° to about 85°. The four relief gates 44 may be equal in arcuate length as indicated between dashed lines 48, 49, and each span an angle Φ from about 2° to about 20°, more preferably from about 4° to about 18°, and most preferably from about 5° to about 15°. Preferably, the arcuate length of each wall segment 42 indicated by the angle θ is larger than the arcuate length of each relief gate 44 indicated by the angle Φ, and more preferably, each wall segment 42 has an arcuate length θ that is from about 3.5 to about 44 times the arcuate length Φ of the relief segment 44, and more preferably from about 4 to about 30, and even more preferably from about 15 to about 17 times the arcuate length +of the relief segment 42. relief gates

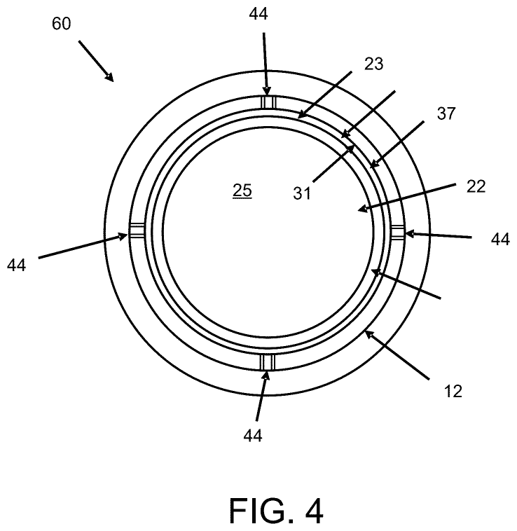

FIG. 4 shows the view of FIG. 3 of the adaptor 10 with the first tubular body 24 present together making an adaptor and tubular body assembly 60. The first tubular body 24 has an internal fluid pathway 25 inside the first socket 22. The annular gap 39 between outer surface 23 of the first tubular body 24 and the interior wall 31 of the first cylindrical wall 12 of the first socket 22 and the laser weld 37 therebetween are illustrated. During use of the adaptor and tubular body assembly 60, debris and liquids can accumulate in the annular gap 39. Each relief segment 44 allows the liquid and debris to drain away from the annular gap 39 through the first cylindrical wall 12 and out of the adaptor 10.

The adaptor 10 is fabricated unitarily and, preferably, in an injection molding process. Suitable materials for forming the adaptor include thermoplastics and thermosetting polymers. Suitable plastics include polyolefins, polyesters, polyamides, polyethers, polysulfones, polyetheramides, polyurethanes, polystyrenes, or others well known to those skilled in the art. The plastics can be homopolymers, copolymers, terpolymers, and block copolymers. Most preferably the plastic is glass filled nylon 6,6 (PA66), or a glass filled polypropylene (PP) or an unfilled PP. The unitary body can be formed by injection molding, plastic welding techniques, thermoforming or other techniques well known to those of ordinary skill in the art.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

1. A tubular body adaptor for connecting a first tubular body with a second tubular body comprising:
a first cylindrical wall has alternating wall segments and relief gates defining a first socket for receiving an end of the first tubular body, all the wall segments span an angle of a least about 70°, a top portion of the first cylindrical wall has a relief segment forming a drain through the first cylindrical wall.

2. The tubular body adaptor of claim 1 wherein the wall segments are of equal length.

3. The tubular body adaptor of claim 2 wherein each of the wall segments has opposed ends with each end having a tapered surface.

4. The tubular body adaptor of claim 1 further comprising a second cylindrical wall supporting the first cylindrical wall and coaxially disposed with respect thereto and having an outer diameter greater than an outer diameter of the first cylindrical wall.

5. The tubular body adaptor of claim 4 further comprising a bridging wall connecting the first cylindrical wall to the second cylindrical wall.

6. The tubular body adaptor of claim 5 wherein the bridging wall has a planar top surface.

7. The tubular body adaptor of claim 4 wherein the second cylindrical wall defines a second socket for receiving an end portion of the second tubular body.

8. The tubular body adaptor of claim 1 wherein the relief segment comprises a generally U-shaped gap.

9. An adaptor and tubular body assembly comprising:
a first tubular body having a first end;
a tubular adaptor having a first cylindrical wall defining a first socket surrounding the first end of the first tubular body, the first cylindrical wall has an annular gap delimited by an exterior surface of the first tubular body and an interior surface of the first socket, and a relief segment is provided through the first cylindrical wall connecting the annular gap to an exterior of the adaptor; and
a weld connecting the interior surface of the tubular adapter to an outer surface of the first tubular body.

10. The assembly of claim 9 wherein the first cylindrical wall has alternating wall segments and relief gates to define a castellated profile.

11. The assembly of claim 10 wherein each of the wall segments has opposed ends with each end having a tapered surface.

12. The assembly of claim 9 further comprising a second cylindrical wall supporting the first cylindrical wall and coaxially disposed with respect thereto and having an outer diameter greater than an outer diameter of the first cylindrical wall.

13. The assembly of claim 12 further comprising a bridging wall connecting the first cylindrical wall to the second cylindrical wall.

14. The assembly of claim 13 wherein the bridging wall has a planar surface.

15. The assembly of claim 12 wherein the second cylindrical wall defines a second socket for receiving a second end portion of a second tubular body.

16. The assembly of claim 2 wherein the first socket has an annular ledge on an interior wall to form a stop abutting the first end portion of the first tubular body.

17. A tubular body adaptor for connecting a first tubular body with a second tubular body comprising:
a first cylindrical wall defining a first female socket for receiving an end of the first tubular body, the first cylindrical wall has a relief segment forming a drain through the first cylindrical wall;
a second cylindrical wall supporting the first cylindrical wall and coaxially disposed with respect thereto and having an outer diameter greater than an outer diameter of the first cylindrical wall and a second female socket for receiving an end of the second tubular body; and
an annular ledge on an interior wall of the first cylindrical wall to form a stop for abutting the end of the second tubular body.

18. The tubular body adaptor of claim 17 wherein the first cylindrical wall has alternating wall segments and relief gates to define a castellated profile and the wall segments span an angle from about 70° to about 88°.

19. The tubular body adaptor of claim 18 wherein each of the wall segments has opposed ends with each end having a tapered surface.

20. The tubular body adaptor of claim 17 further comprising a bridging wall connecting the first cylindrical wall to the second cylindrical wall.
